(19) United States
(12) Patent Application Publication
(10) Pub. No.: US 2014/0223118 A1
(43) Pub. Date: Aug. 7, 2014

(54) Bit Markers and Frequency Converters

(71) Applicant: Brian Ignomirello, Colts Neck, NJ (US)

(72) Inventor: Brian Ignomirello, Colts Neck, NJ (US)

(21) Appl. No.: 13/756,921

(22) Filed: Feb. 1, 2013

(51) Int. Cl. G06F 12/16

(52) U.S. Cl. CPC G06F 12/16
USPC 711/161

(57) ABSTRACT

Through the encoding of binary data, one may store the same information as contained in data that is not encoded, but do so within a smaller space. This encoding will permit economies to be realized because fewer storage areas within recording media will be used.

### FIELD OF THE INVENTION

The present invention relates to the field of data storage.

### BACKGROUND OF THE INVENTION

The twenty-first century has witnessed an exponential growth in the amount of digitized information that people and companies generate and store. This information is composed of electronic data that is typically stored on magnetic surfaces such as disks, which contain small regions that are sub-micrometer in size and are capable of storing individual binary pieces of information.

Because of the large amount of data that many entities generate, the data storage industry has turned to network-based storage systems. These types of storage systems may include at least one storage server, which is a processing system that is configured to store and to retrieve data on behalf of one or more entities. The data may be stored and retrieved as storage objects, such as blocks and/or files.

One system that is used for storage is a Network Attached Storage (NAS) system. In the context of NAS, a storage server operates on behalf of one or more clients to store and to manage file-level access to data. The files may be stored in a storage system that includes one or more arrays of mass storage devices, such as magnetic or optical disks or tapes. This data storage scheme may employ Redundant Array of Independent Disks (RAID) technology.

Another system is a Storage Area Network (SAN). In a SAN system, typically a storage server provides clients with block-level access to stored data, rather than file-level access. However, some storage servers are capable of providing clients with both file-level access and block-level access.

Regardless of whether one uses NAS or SAN, the storage of electronic data presents two primary challenges: (1) how to protect against loss of data; and (2) how to reduce the costs of storing data. Unfortunately, these two challenges push a person in desire of storing data in different directions.

Traditionally, in order to protect against a loss of data, persons made back-up copies of their data. As persons of ordinary skill in the art are aware, instead of making complete duplicates of all disks, they can take advantage of RAID technologies. However, RAID technologies provide localized data protection that primarily protects against corruption of data, not destruction of disks. Thus, depending on the extent of physical harm that may befall the physical environment of a disk, the use of RAID technologies may or may not be effective because the same physical harm may befall the copy or copies.

Additionally or alternatively, one can make use of data replication technology that calls for the transmission of digital information over a network to a distal site. However, there is a physical distance constraint that is a function of the distance between sites and that limits the effectiveness of this strategy. For example, limitations are imposed by the speed of light, the rate of data ingestion, and the rate of daily data change. Moreover, there are economic costs associated with making an additional copy and storing an additional copy of a data, and there is a devotion of time that is necessary when one makes copies.

Therefore, there is a need for new methods and systems for economically storing data.

### SUMMARY OF THE INVENTION

The present invention provides methods, systems, computer program products and technologies for improving the efficiency of storing data. By encoding raw data and storing the encoded data, one can reduce the amount of storage needed for a given file. Because the present invention works with raw data, there is no limitation based on the type of file to be stored. Through the various embodiments of the present invention, one may transform data and/or change the physical devices on which the transformed or encoded data is stored. This may be accomplished through automated processes that employ a computer that comprises or is operably coupled to a computer program product that when executed carries out one or more of the methods of the present invention.

According to a first embodiment, the present invention is directed to a method for storing data on a recording medium comprising: (i) receiving a plurality of digital binary signals, wherein the digital binary signals are organized in a plurality of chunklets, wherein each chunklet is N bits long, wherein N is an integer number greater than 1 and wherein the chunklets have an order; (ii) dividing each chunklet into subunits of a uniform size and assigning a marker to each subunit from a set of X markers to form a set of a plurality of markers, wherein X equals the number of different combinations of bits within a subunit, identical subunits are assigned the same marker and at least one marker is smaller than the size of a subunit; and (iii) storing the set of the plurality of markers on a non-transitory recording medium in either an order that corresponds to the order of the chunklets or another manner that permits recreation of the order of the chunklets.

According to a second embodiment, the present invention is directed to a method for retrieving data from a recording medium comprising: (i) accessing a recording medium, wherein the recording medium stores a plurality of markers in an order; (ii) translating the plurality of markers into a set of chunklets, wherein each chunklet is N bits long, wherein N is an integer number greater than 1 and wherein the chunklets have an order that corresponds to the order of the plurality of markers and wherein the translating is accomplished by accessing a bit marker table, wherein within the bit marker table each unique marker is identified as corresponding to a unique string of bits; and (iii) generating an output that comprises the set of chunklets. The markers may or may not be stored in an order that corresponds to the order of the chunklets but regardless of the order in which they are stored, one can recreate the order of the chunklets.

According to a third embodiment, the present invention is directed to a method for storing data on a recording medium comprising: (i) receiving a plurality of digital binary signals, wherein the digital binary signals are organized in chunklets, wherein each chunklet is N bits long, each chunklet has a first end and a second end, N is an integer number greater than 1, and the chunklets have an order; (ii) dividing each chunklet into a plurality of subunits, wherein each subunit is A bits long; (iii) analyzing each subunit to determine if the bit at the second end has value 0 and if the bit at the second end has a value 0, removing the bit at the second end and all bits that have the value 0 and form a contiguous string of bits with the bit at the second end, thereby forming a revised chunklet for any chunklet that has a 0 at the second end; and (iv) on a non-transitory recording medium, storing each revised subunit and each subunit that is A bits long and has a 1 at its second end in a manner that permits reconstruction of the chunklets in the order. For example, the revised subunits (and any subunits that were not revised) may be organized in an order that corresponds to the order of the subunits within each chunklet prior to being revised.

According to a fourth embodiment, the present invention provides a method for storing data on a recording medium comprising: (i) receiving a plurality of digital binary signals, wherein the digital binary signals are organized in chunklets, wherein each chunklet is N bits long, each chunklet has a first end and a second end, N is an integer number greater than 1, and the chunklets have an order; (ii) analyzing each chunklet to determine if the bit at the first end has a value 0 and if the bit at the first end has a value 0, removing the bit at the first end and all bits that have the value 0 and form a contiguous string of bits with the bit at the first end, thereby forming a first revised chunklet for any chunklet that has a 0 at the first end; (iii) analyzing each chunklet to determine if the bit at the second end has a value 0 and if the bit at the second end has a value 0, removing the bit at the second end and all bits that have the value 0 and form a contiguous string of bits with the bit at the second end, thereby forming a second revised chunklet for any chunklet that has a 0 at the second end; (iv) for each chunklet (a) if the sizes of the first revised chunklet and the second revised chunklet are the same, storing the first revised chunklet or the second revised chunklet, (b) if the first revised chunklet is smaller than the second revised chunklet, storing the first revised chunklet, (c) if the second revised chunklet is smaller than the first revised chunklet, storing the second revised chunklet, (d) if there are no revised chunklets, storing the chunklet, (e) if there is no first revised chunklet, but there is a second revised chunklet, then storing the second revised chunklet, (f) if there is no second revised chunklet, but there is a first revised chunklet, then storing the first revised chunklet, wherein each revised chunklet that is stored, is stored with information that indicates if one or more bits were removed from the first end or the second end. The information that indicates if one or more bits were removed from the first end or the second end may for example be in the form of the uniqueness of the subunit.

According to fifth embodiment, the present invention provides a method for storing data on a recording medium comprising: (i) receiving a plurality of digital binary signals, wherein the digital binary signals are organized in chunklets, wherein each chunklet is N bits long, each chunklet has a first end and a second end, N is an integer number greater than 1, and the chunklets have an order; (ii) dividing each chunklet into a plurality of subunits, wherein each subunit is A bits long; (iii) analyzing each subunit to determine if the bit at the first end has a value 0 and if the bit at the first end has a value 0, removing the bit at the first end and all bits that have the value 0 and form a contiguous string of bits with the bit at the first end, thereby forming a first revised subunit for any subunit that has a 0 at the first end; (iv) analyzing each subunit to determine if the bit at the second end has value 0 and if the bit at the second end has a value 0, removing the bit at the second end and all bits that have the value 0 and form a contiguous string of bits with the bit at the second end, thereby forming a second revised subunit for any subunit that has a 0 at the second end; and (v) for each subunit (a) if the sizes of the first revised subunit and the second revised subunit are the same, storing the first revised subunit or the second revised subunit (b) if the first revised subunit is smaller than the second revised subunit, storing the first revised subunit, (c) if the second revised subunit is smaller than the first revised subunit, storing the second revised subunit, (d) if there are no revised subunits, storing the subunit, (e) if there is no first revised subunit, but there is a second revised subunit, storing the second revised subunit, (f) if there is no second revised subunit, but there is a first revised subunit, storing the first revised subunit, wherein each revised subunit that is stored is stored with information that indicates if one or more bits were removed from the first end or the second end. The information that indicates if one or more bits were removed from the first end or the second end may for example be in the form of the uniqueness of the subunit.

According to a sixth embodiment, the present invention provides a method for retrieving data from a recording medium comprising: (i) accessing a recording medium, wherein the recording medium stores a plurality of data units in a plurality of locations, wherein each data unit contains a plurality of bits and the maximum size of the data unit is N bits, at least one data unit contains fewer than N bits and the data units have an order; (ii) retrieving the data units and adding one or more bits at an end of any data unit that is fewer than N bits long to generate a set of chunklets that corresponds to the data units, wherein each chunklet contains the same number of bits; and (iii) generating an output that comprises the set of chunklets in an order that corresponds to the order of the data units.

Through the various embodiments of the present invention, one can increase the efficiency of storing data by reducing the size of a data file. The increased efficiency may be realized by using less storage space than is used in commonly used methods and investing less time and effort in the activity of storing information. These benefits may be realized when storing data either remotely or locally, and the various embodiments of the present invention may be used in conjunction with or independent of RAID technologies.

### BRIEF DESCRIPTION OF THE FIGURE

FIG. 1 is a representation of an overview of a method of the present invention.

### DETAILED DESCRIPTION OF THE INVENTION

Reference will now be made in detail to various embodiments of the present invention, an example of which is illustrated in the accompanying figure. In the following detailed description, numerous specific details are set forth in order to provide a thorough understanding of the present invention. However, unless otherwise indicated or implicit from context, the details are intended to be examples and should not be deemed to limit the scope of the invention in any way.

Definitions

Unless otherwise stated or implicit from context the following terms and phrases have the meanings provided below.

The term “bit” refers to a binary digit. It can have one of two values, either 0 or 1. A bit is the smallest unit that is stored on a recording medium.

The term “block” refers to a sequence of bytes or bits of data having a predetermined length. Thus, a block is a unit that a file system views as corresponding to a file.

The term “byte” refers to the combination of eight bits in a sequence.

The term “chunklet” refers to a set of bits that may correspond to a sector cluster. The size of chunklet is determined by the storage system and may have a size N. Traditionally, N was derived by the CHS scheme, which addressed blocks by means of a tuple that defines the cylinder, head and sector at which they appeared on hard disks. More recently, N has been derived from the LBA measurement, which refers to logical block addressing, and is another means for specifying the location of blocks of data that are stored on computer storage devices. By way of example, a common N is 512 B, 1K, 2K, 4K, 8K, 16K, 32K, 64K or 1 MB. As persons of ordinary skill in the art are aware 1K=1024 B.

A “file” is a collection of related bytes or bits having an arbitrary length.

The phrase “file system” refers to an abstraction that is used to store, to retrieve and to update a set of files. Thus, the file system is the tool that is used to manage access to the data and the metadata of files, as well as the available space on the storage devices that contain the data. Some file systems may for example reside on a server.

The abbreviation “LBA” refer to logical block addressing. LBA is a linear addressing scheme and is the system that is used for specifying the location of blocks of data that is stored in certain storage media, e.g., hard disks. In a LBA scheme, blocks are located by integer numbers. Typically, the first block is block 0.

The abbreviation “NAS” refers to network area storage. In a NAS system, a disk array may be connected to a controller that gives access to a local area network transport.

The phrase “operating system” refers to the software that manages computer hardware resources. Examples of operating systems include but are not limited to Microsoft Windows, Linux, and Mac OS X.

The abbreviation “RAID” refers to a redundant array of independent disks. To the relevant server, the group of disks may look like a single volume. RAID technologies improve performance by pulling a single strip of data from multiple disks.

The phrase “recording medium” refers to a non-transitory medium in which one can store magnetic signals that correspond to bits. By way of example, a recording medium includes but is not limited to non-cache media such as hard disks and solid state drives. As persons of ordinary skill in the art know, solid state drives also have cache and do not need to spin.

The abbreviation “SAN” refers to a storage area network. This type of network can be used to link computing devices to disks, tape arrays and other recording media. Data may for example be transmitted over a SAN.

The abbreviation “SAP” refers to a system assist processor, which is an I/O (input/output) engine that is used by operating systems.

The abbreviation “SCSI” refers to a small computer systems interface.

The term “sector” refers to a subdivision of a track on a disk, for example a magnetic disk. Each sector stores a fixed amount of data. Common sector sizes for disks are 512 bytes (512 B), 2048 bytes (2048 B), and 4096 bytes (4K). If a chunklet is 4K in size, and each sector is 512 B, then each chunklet corresponds to 8 sectors (4*1024/512=8).

### Preferred Embodiments

According to one embodiment, the present invention is directed to a method for storing data on a recording medium. The method provides for receipt of a file and conversion of the data that forms the file into a set of signals for storage.

The signals may be received from a person or entity that is referred to as a host. The host will send the signals in the form of raw data, e.g., the host may send one or more chunklets that individually or collectively form files. Some of the methods of the present invention may begin after the receipt of chunklets or the receipt of subunits of chunklets or by conversion of the chunklets into subunits.

Typically, for a given file, each chunklet contains the same number of bits. If any chunklet does not have that number of bits, e.g., one or more chunklets has a smaller number of bits, the system may add bits, e.g., zeroes, until all chunklets are the same size.

The methods may be configured to work with data that is organized in chunklets that are N bits long. As noted above, each bit is either a zero or a one, and N is an integer that is greater than one. The methods may be used with any size chunklet that contains a plurality of bits. However, efficiencies are maximized when the chunklets are of sizes typically used in the industry today or larger. By way of an example, each chunklet may be 4K, which corresponds to 4096 B.

The chunklets as received have an order and the methods of the present invention permit the information that identifies this order to be retained. For example, they may cause the storage of encoded data in the same order as the data within a chunklet, and if there is a plurality of chunklets, the order of the chunklets will be retained or the ability to recreate the order will be retained.

Optionally, the system may divide the chunklets into groups of bits, also referred to as subunits, each of which is A bits long. If the system divides the bits into subunits, the subunits may be compared to a bit marker table. If the system does not divide the chunklets into subunits, then each chunklet may be compared to a bit marker table.

The table correlates each unique set of bits with a unique marker. Thus, under this method a computer program may receive a set of chunklets as input. It may then divide each chunklet into Y subunits that are the same size and that are each A bits long, wherein A/8 is an integer. For each unique A, there may be a marker within the table.

Through an automated protocol, after receipt of the chunklets a computer program product causes the bit marker table to be accessed. Thus, each chunklet or subunit may serve as an input, and each bit marker may serve as an output, thereby forming an output set of markers. In embodiments in which each chunklet is not subdivided, then each chunklet would receive one marker. If the chunklet is divided into two subunits, it would be translated or encoded into two markers. Thus, the computer program product uses the bit marker table to assign at least one marker that corresponds to each chunklet. The computer program product may be designed such that a different output is generated that corresponds to each individual marker, a different output is generated that contains a set of markers that corresponds to each chunklet or a different output is generated that contains the set of markers that corresponds to a complete file.

The bit marker table contains X markers, wherein X equals either the number of different combinations of bits within a chunklet of length N, if the method does not divide the chunklets into subunits, or the number of different combinations of bits within a subunit of length A, if the method divides the chunklets. If documents types are known or expected to have fewer than all of the combinations of bits for a given length subunit or chunklet, X (the number of markers) can be smaller than the number of combinations of bits.

For at least a plurality of the unique combination of bits within the table, preferably if the system does not divide the chunklets into subunits the marker is smaller than chunklet length N or if the system does divide the chunklets into subunits, smaller than subunit length A. Preferably if the system does not divide the chunklets into subunits, no markers are larger than chunklet length N, or if the system does divide the chunklets into subunits, no markers are larger than subunit length A. In some embodiments, all markers are smaller than N. Additionally, in some embodiments, each marker may be the same size or two or more markers may different sizes. When there are markers of different sizes, these different sized markers may for example be in the table. Alternatively, within the table all markers are the same size, but prior to storage all 0 s are removed from one or both ends of the markers.

After the computer program product translates the chunklets into a plurality of markers, it causes the plurality of markers (with or without having had 0's removed from an end) to be stored on a non-transitory recording medium in an order that corresponds to the order of the chunklets or from which the order of the chunklets may otherwise be recreated. Ultimately, the markers are to be stored in a non-transitory medium that is a non-cache-medium. However, optionally, they may first be sent to a cache medium, e.g., L1 and/or L2.

Within the bit marker table each unique marker is identified as corresponding to unique strings of bits. The table may be stored in any format that is commonly known or that comes to be known for storing tables and that permits a computer algorithm to obtain an output that is assigned to each input.

Within the table, preferably a plurality, at least 50%, at least 60%, at least 70%, at least 80%, at least 90%, or at least 95% of the markers are smaller in size than the subunits. Table I below provides an example of excerpts from a bit marker table where the subunits are 8 bits long. As the table shows, each bit marker is stored in binary code. Optionally one could supply a bit marker number (in a based 10 system) to refer to each bit marker, but at persons or ordinary skill in the art recognize all storage is based on a bits.

TABLE I

| Bit Marker (as stored) | Subunit = 8 bits (input) |
|---|---|
| 0101 | 00000001 |
| 1011 | 00000010 |
| 1100 | 00000011 |
| 1000 | 00000100 |
| 1010 | 00000101 |
| 11111101 | 11111101 |

By way of example and using the subunits identified in Table I, if the input were 00000101 00000100 00000101 00000101 00000001, the output would be: 1010 1000 1010 1010 0101. When the bit marker output is smaller than the subunit input, it will take up less space on a storage medium, and thereby conserve both storage space and the time necessary to store the bits.

As a person of ordinary skill in the art will recognize, in a given bit marker table such as that excerpted to produce Table I, there will need to be 2^{N} entries, wherein N corresponds to the number of bits within a subunit. When there are 8 bits, there are 256 entries needed. When there are 16 bits in a subunit one needs 2¹⁶ entries, which equals 65,536 entries. When there are 32 bits in a subunit, one needs 2³² entries, which equals 4,294,967,296 entries.

Because as the subunit size gets larger the table becomes more cumbersome, in some embodiments, the table may be configured such that all zeroes from one end of the subunit are missing and prior to accessing the table, all zeroes from that end of each subunit are removed. Thus, rather than Table I, Table II could be consulted.

TABLE II

| Bit Marker (output) | Pre-processed Subunit |
|---|---|
| 0101 | 00000001 |
| 1011 | 0000001 |
| 1100 | 00000011 |
| 1000 | 000001 |
| 1010 | 00000101 |
| 11111101 | 11111101 |

As one can see, in the second and fourth lines, after the subunits were pre-processed, they had fewer than eight bits. However, the actual subunits in the raw data received from the host all had eight bits. Because the system in which the methods are implemented can be designed to understand that the absence of a digit implies a zero and all absences of digits are at the same end of any truncated subunits, one can use a table that takes up less space and that retains the ability to assign unique markers to unique subunits. Thus, the methods permit the system to interpret 00000001 (seven zeroes and a one) and 0000001 (six zeroes and a one) as different.

In order to implement this method, one may deem each subunit (or each chunklet if subunits are not used) to have a first end and a second end. The first end can be either the right side of the string of bits or the left side, and the second end would be the opposite side. For purposes of illustration, one may think of the first end as being the leftmost digit and the second end as being the rightmost digit. Under this method one then analyzes one or more bits within each subunit of each chunklet to determine if the bit at the second end has a value 0. This step may be referred to as preprocessing and the subunits after they are preprocessed appear in the right column of Table II. If the bit at the second end has a value 0, the method may remove the bit at the second end and all bits that have the value 0 and form a contiguous string of bits with that bit, thereby forming a revised subunit (pre-processed subunit in the table) for any subunit that originally had a 0 at the second end.

One may use a computer algorithm that reviews each subunit to determine whether at the second end there is a 0 and if so removes the 0 to form the pre-processed subunit, which also may be referred to as a revised subunit with a revised second end at a position that was adjacent to the second end of the subunit. Next, the algorithm reviews the revised subunit to determine whether at its now revised second end there is a 0 and if so removing the 0 to form a further revised second end. In this method, the revised second end would be the location that was previously adjacent to the bit at the second end. Any further revised second end would have been two or more places away from the second end of the subunit. Thus, the term “revised” means a shortened or truncated second end. The algorithm may repeat this method for the revised subunit until a shortened chunklet is generated that has a 1 at its second end.

As persons of ordinary skill in the art will recognize, the aforementioned method is described as being applied by removing zeroes from the second end until a 1 is at the revised second end or further revised second end. The methods could be designed in reverse so that the system removes ones from the second end until a 0 is at a revised second end or further revised second end. Additionally, with the present disclosure a person of ordinary skill in the art could remove bits from the first end instead of the second end and use a table created to convert those revised subunits into bit markers.

The above described method assigns bit markers independent of the frequency with which subunits are likely to appear in a given document. However, based on empirical analysis, one can determine the frequency of each subunit within a type of document or a set of documents received from a particular host or from within a set of documents that have been received within a given timeframe, e.g., the past year or past two years. With this information, rather than look to a table as illustrated in Table I or Table II in which the subunits are organized in numerical order, one could look to a frequency converter in which the smaller bit markers are associated with subunits that are predicted most likely to appear within a file, within a type of file or within a set of files as received from a particular host. Thus, with the frequency converter, the markers are a plurality of different sizes and markers of a smaller size are correlated with higher frequency subunits.

The strategy described in the previous paragraph takes advantage of the fact that approximately 80% of all information is contained within approximately the top 20% of the most frequent subunits. In other words, the subunits that correspond to data are highly repetitive. Table III is an example of an excerpt from a frequency converter that uses the same subunits as Table I. However, one will note that the bit markers are not assigned in sequence, and instead larger bit markers are assigned to lower frequency subunits. As the table illustrates, the marker that is assigned to subunit 00000011 is twenty five percent larger than that assigned to subunit 00000001, and for subunit 11111101, despite being of high numerical value, it receives a smaller bit marker because it appears frequently in the types of files received from the particular host. Thus, if one used Table I and the subunit 11111101 appears in 10,000 places, it would correspond to 111,111,010,000 bits. However, if one used Table III, only 11,000,000 bits would need to be used for storage purposes for the same information. Although not shown in this method, the subunits could be preprocessed to remove zeroes from one end or the other, and the table could be designed to contain the correlating truncated subunits.

TABLE III
Frequency Converter

| | | Subunit = 8 |
|---|---|---|
| Bit Marker (output) | Frequency | bits (input) |
| 0101 | 16% | 00000001 |
| 1000 | 15% | 00000010 |
| 11011 | 10% | 00000011 |
| 10011101 | 0.00001% | 00000100 |
| 10111110 | 0.00001% | 00000101 |
| 1100 | 15% | 11111101 |

As noted above, frequency converters can be generated based on analyses of a set of files that are deemed to be representative of data that is likely to be received from one or more hosts. In some embodiments, the algorithm that processes the information could perform its own quality control and compare the actual frequencies of subunits for documents from a given time period with those on which the allocation of the marker in the frequency converter are based. Using statistical analyses it may then determine if for future uses a new table should be created that reallocates how the markers are associated with the subunits. As a person of ordinary skill in the art will recognize, Table III is a simplified excerpt of a frequency converter. However, in practice one may choose a hexadecimal system in order to obtain the correlations. Additionally, the recitation of the frequencies on which the table is based is included for the convenience of the reader, and it need not be included in the table as accessed by the various embodiments of the present invention.

According to another embodiment, the present provides a method for retrieving data from a recording medium. In this method, one begins by accessing a recording medium. The recording medium stores a plurality of markers in an order, and from these markers, one can recreate a file. Access may be initiated by host requesting retrieval of a file and transmitting the request to a storage area network or by the administrator of the storage area network.

Retrieval of the data as stored may be through processes and technologies that are now known or that come to be known and that a person of ordinary skill in the art would appreciate as being of use in connection with the present invention. For example, markers may be retrieved through parallel processing.

After the data is retrieved from a recording medium, one translates the plurality of markers into bits that may be used to form chunklets. The markers may be stored such that each marker corresponds to a chunklet or each marker corresponds to a subunit and a plurality of subunits may be combined to form a marker. In the stored format, the markers are arranged in an order that permits recreation of bits within chunklets and recreation of the order of chunklets in a manner that allows for recreation of the stored document.

When the markers are retrieved, they may or may not be of a uniform size. If they are of a uniform size, then the system will convert each marker into longer strings of bits, e.g., subunits or chunklets. If the markers are not the same size, then the system may by default add bits to one pre-defined end until all of the markers are made the same length. For example, 0′s may be added to the right side of all markers that contain fewer than the number of markers need for a look-up table to be used to generate longer strings of bits, which may be subunits or chunklets. The markers may be stored in the same order as the subunits and chunklets, thereby allowing for a file to be recreated with the bits are in the correct order.

As with the previous embodiments, each chunklet may be N bits long, wherein N is an integer number greater than 1 and each subunit may be A bits long, wherein A is an integer. In order to translate the markers into chunklets, one may access a bit marker table or a frequency converter. Within the bit marker table or frequency converter, there may be a unique marker that is associated with each unique string of bits. If the table is organized in a format similar to Table II, after translation, zeroes may be added in order to have each subunit and chunklet be the same size.

After the chunklets are formed, one will have an output that corresponds to binary data from which a document can be reconstituted. Optionally, one may associate the file with a file type. For example the host may keep track or the MIME translator and re-associate it with the file upon return. The file type will direct the recipient of the data to know which operating system should be used to open it. As a person of ordinary skill in the art will recognize, the storage area network needs not keep track of the file type, and in some embodiments does not.

As noted above and discussed in connection with Table II, prior to translating in a bit marker table, one may truncate all remaining zeroes from a subunit. However, in another embodiment, rather than translate through the use of a bit marker table or a frequency converter, one could store the truncated subunits in the same order that they exist within the chunklets (or if subunits are not used, then the chunklets could be truncated and stored).

Thus, in some embodiments, there is another method for storing data on a recording medium. According to this method, one receives a plurality of digital binary signals, wherein the digital binary signals are organized in chunklets that are in a format as described above. Optionally, each chunklet may be divided into subunits as provided above.

Each chunklet or subunit may be defined by its length and each chunklet or subunit has a first end and a second end. One may analyze each chunklet or subunit to determine if the bit at the second end has value 0 and if the bit at the second end has a value 0, remove the bit at the second end and all bits that both have the value 0 and form a contiguous string of bits with that bit at the second end, thereby forming a revised chunklet or a revised subunit for any chunklet or subunit that has a 0 at the second end.

After the chunklets or subunits are truncated, one may store the truncated information in a non-transitory recording medium. By storing truncated information, fewer bits are used for storing the same information that otherwise would have been stored in strings of bits that was not truncated.

As persons of ordinary skill in the art will recognize, although the method described above is described in connection with removing zeroes, the system could instead remove ones.

Additionally, in the method described above one can remove the digit(s) from the first end or the second end of each subunit or of each chunklet, but not both. However, it is within the scope of the present invention to practice methods in which one considers removing digits from the first end of each subunit or chunklet, one separately considers removing digits from the second end of each subunit or chunklet, for each subunit or chunklet one analyzes whether truncation occurs at either, one or both of the first end and the second end, and if it occurs at only one end, saving the truncated chunklet or subunit, and if it occurs at both ends, then saving the smaller of the truncated units. It is within the scope of the present invention to practice methods in which digits could be removed from both ends of a chunklet or subunit.

Thus, one may receive a plurality of digital binary signals. The binary signals may be received in units, e.g., chunklets or subunits of chunklets. Each unit may be the same number of bits long, and each unit has a first end and a second end. The number of bits within a unit is an integer number greater than 1, and the bits have an order within the units, and the units have an order.

One may then analyze each unit in order to determine if the bit at the first end has a value 0 and if the bit at the first end has a value 0, removing the bit at the first end and all bits that both have the value 0 and form a contiguous string of bits with that bit, thereby forming a first revised unit for any unit that has a 0 at the first end.

One may also analyze each unit to determine if the bit at the second end has value 0 and if the bit at the second end has a value 0, removing the bit at the second end and all bits that both have the value 0 and form a contiguous string of bits with that bit, thereby forming a second revised unit for any unit that has a 0 at the second end.

For each unit, the following decision tree may be applied: (a) if the sizes of the first revised unit and the second revised unit are the same, storing the first revised unit or the second revised subunit; (b) if the first revised unit is smaller than the second revised unit, storing the first revised unit; (c) if the second revised unit is smaller than the first revised unit, storing the second revised unit; (d) if there are no revised units, storing the unit; (e) if there is no first revised unit, but there is a second revised unit storing the second revised unit; and (f) if there is no second revised unit, but there is a first revised unit storing the first revised unit. One may also store information that indicates if one or more bits were removed from the first end or the second end or one could use a first bit marker table for units for which bits are removed from the first end and a second bit marker table for units for which bit markers are removed from the second end, and between the two bit marker tables, there are no duplications of bit markers. These two different bit marker tables can be organized as sections of the same table and include bit markers for units that are not revised. In the table or tables, there are no duplications of the bit markers for first revised units, second revised units and any units that are not revised because for example they have 1s at both ends.

When storing the truncated data, even in the absence of availing oneself of the bit marker table or a frequency converter, one may retrieve the data. One may do so by accessing a recording medium, wherein the recording medium stores a plurality of data units in a plurality of location, wherein each data unit contains a plurality of bits and the maximum size of the data unit is a first number of bits, at least one data unit contains a second number of bits, wherein the second number of bits is smaller than the first number of bits.

Next one may retrieve the data units and add one or more bits at an end of any data unit that is fewer than N bits long to generate a set of chunklets that corresponds to the data units, wherein each chunklet contains the same number of bits; and generate an output that comprises the set of chunklets in an order that corresponds to the order of the data units. If the truncated data were formed by removing zeroes, then when retrieving the data, one will add the zeroes back. Additionally, if the stored data units were subunits of chunklets, the system may first add back zeroes to truncated subunits in order to generate subunits of a uniform size and then combine the subunits to form the chunklets.

After generating the data, optionally one may associate the output with a file type and transmit the output to an operating system that is capable of converting the chunklets into a document of that file type. Alternatively, transmission may be made without the file type. In those cases the recipient would associate the decoded data with a file type.

In order to facilitate explanation of the present invention, the methods provided above were described without reference to specific architecture. However, in order to illustrate the various embodiments further and to provide context, reference is made below to specific hardware that one may use, which may be combined to form a system to implement the methods of the present invention.

In some embodiments, a host may generate documents and files in any manner at a first location. The documents will be generated by the host's operating system and organized for storage by the host's file system. The present invention is not limited by the type of operating system or file system that a host uses.

At that first location a SAP executes a protocol for storing the data that correlates to documents or files. The SAP formats the data into chunklets that are for example 4K in size.

The data may be sent over a SAN to a computer that has one or more modules or to a computer or set of computers that are configured to receive the data. The computers comprise and/or are operably coupled to one or more central processing units, memory and one or more communication portals that are configured to permit the communication of information with one or more hosts and one or more storage devices locally and/or over a network.

Additionally, there may be a computer program product that stores an executable computer code on hardware, software or a combination of hardware and software. The computer program product may be divided into or able to communicate with one or more modules that are configured to carry out the methods of the present invention.

For example there may be a level 1 (L1) cache and a level 2 cache (L2). As persons of ordinary skill in the art are aware, the use of cache technology has traditionally allowed for one to increase efficiency in storing data. In the present invention, by way of an example, the data may be sent over a SAN to a cache and the data may be sent to the cache prior to consulting a bit marker table, prior to consulting a frequency converter, and prior truncating bits, and/or after consulting a bit marker table, after consulting a frequency converter, and after truncating bits.

Transmission may be wired or wireless.

Assuming that the sector size is 512 B, for each chunklet that is 4K in size, the host will expect that 8 sectors of storage are to be used.

After the data is received or as the data is being received, an algorithm may be executed that divides chunklets into subunits of for example 32 bits. The size of the subunits is a choice of the designer of the system that receives the data from the host. However, the size of the subunits should be selected such that the chunklets are divided into subunits of a consistent size, and the subunits can easily be used in connection with consultation of a bit marker table or a frequency converter.

If any of the chunklets are smaller than the others, optionally, upon receipt of that chunklet of the smaller size, the algorithm adds zeroes in order to render the smaller chunklet to be the same size as the other chunklets. Alternatively, the system may divide the chunklets into subunits and upon obtaining a subunit that is smaller than the desired length, add zeroes to an end of that subunit.

The SAN, according to directions stored in a computer program product, may access a bit marker table or frequency converter. These resources correlate a bit marker with each of the subunits and generate an output. Because most, if not all, of the bit markers are smaller in size than the subunits, the output is a data file that is smaller than the input file that was received from the host. Thus, whereas a file as received from the host may be a size R, the actual data as saved by the SAN may be S, wherein R>S. Preferably, R is at least twice as large as S, and more preferably R is at least three times as large as S.

The SAN takes the output file and stores it in a non-transitory storage medium, e.g., non-cache media. Preferably, the SAN correlates the file as stored with the file as received from the host such that the host can retrieve the file.

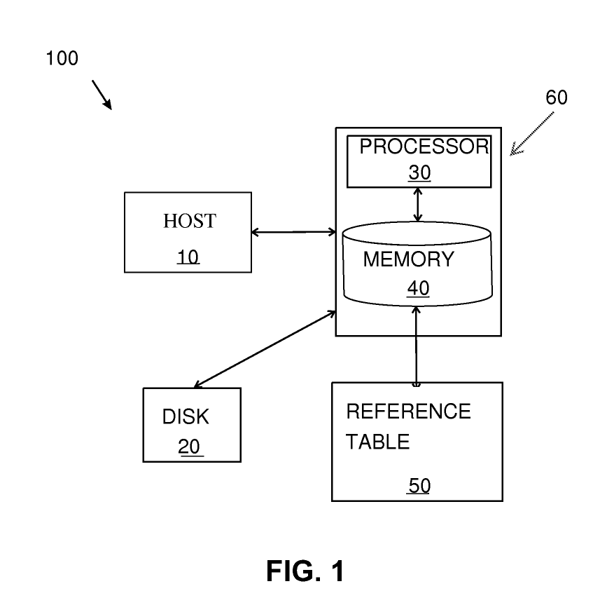

For purposes of further illustration, reference may be made to FIG. 1, which shows a system for implementing methods of the present invention. In the system 100, the host 10, transmits files to a storage area network, 60, that contains a processor 30 that is operably coupled to memory 40. Optionally, the storage area network confirms receipt back to the host.

Within the memory is stored a computer program product that is designed to take the chunklets and to divide the data contained therein into subunits.

The memory may also contain or be operably coupled to a reference table 50. The table contains bit markers for one or more of the subunits, and the computer program product creates a new data file that contains one or more of the bit markers in place of the original subunits.

The processor next causes storage of the bit markers on a recording medium, such as a non-cache medium, which may for example be a disk 20. In some embodiments, initially all of the bit markers are the same size; however, prior to storing them, one or more, preferably at least 25%, at least 50%, or at least 75% are truncated prior to storage.

According to any of the methods of the present invention, data that is stored in an encoded form is capable of being retrieved and decoded before returning it to a host. Through the use of one or more algorithms that permit the retrieval of the encoded data, the accessing of the reference table or frequency converter described above and the conversion back into a string of bits and chunklets, files can transmitted to and recreated by a host. By way of a non-limiting example, the data may be encoded and stored in a format that contains an indication where one marker ends. Thus, the pool of markers may be selected such that by their uniqueness, upon being read the system knows where one marker ends and the next one begins.

Additionally, in some embodiments, after each marker is read, all markers may be made the same length i.e., the same number of bits. Next the markers may run through a look up table in order to determine what subunits or chunklets correspond to which markers. If subunits are generated, the subunits may be combined to form chunklets, and the chunklets may be assembled order to form the file.

Furthermore, it is within the scope of the present invention to store markers of a first size and then to add 0′s (or alternatively l′s) to either or both ends of the marker as stored. As a person of ordinary skill in the art will recognize. The benefit of storing fewer binary signals is that less storage space is needed for a given file.

When a look-up table is used, preferably it is stored in the memory of a computing device. In some embodiments, the look-up table is static and the markers are pre-determined. Thus, when storing a plurality of documents of one or more different document types over time, the same table may be used. Optionally, it could be stored at the location of a host or as part of a storage area network.

In one embodiment, a storage device stores a plurality of bit markers in a non-cache medium that correspond to a given file. The bit markers are of a size range X to Y, wherein X is less than Y and at least two markers have different sizes. As or after the bit markers are retrieved, a computer algorithm adds 0's to one end of all bit markers than are smaller than a predetermined size of Z, wherein Z is greater or equal to Y. A look up table may be consulted in which each marker of size Z is translated into strings of bits of length A, wherein A is greater than or equal to Z. In a non-limiting example, X=4, Y=20, Z=24, A=32. In some embodiments, A is at least 50% larger than Z. The string of bits that correspond to A may be subunits that are combined into chunklets or they may be chunklets themselves.

Any of the features of the various embodiments described herein can be used in conjunction with features described in connection with any other embodiments disclosed unless otherwise specified. Thus, features described in connection with the various or specific embodiments are not to be construed as not suitable in connection with other embodiments disclosed herein unless such exclusivity is explicitly stated or implicit from context.

I claim:

1. A method for storing data on a recording medium comprising:
i. receiving a plurality of digital binary signals, wherein the digital binary signals are organized in a plurality of chunklets, wherein each chunklet is N bits long, wherein N is an integer number greater than 1 and wherein the chunklets have an order;
ii. dividing each chunklet into subunits of a uniform size and assigning a marker to each subunit from a set of X markers to form a set of a plurality of markers, wherein X equals the number of different combinations of bits within a subunit, identical subunits are assigned the same marker and at least one marker is smaller than the size of a subunit; and
iii. storing the set of the plurality of markers on a non-transitory recording medium in an order that corresponds to the order of the chunklets.

2. The method according to claim 1, wherein said assigning comprises accessing a bit marker table, wherein within the bit marker table each unique marker is identified as corresponding to a unique string of bits.

3. The method according to claim 2, wherein each subunit has a first end and a second end and prior to assigning said marker, the method further comprises analyzing one or more bits within each subunit of each chunklet to determine if the bit at the second end has a value 0 and if the bit at the second end has a value 0, removing the bit at the second end and all bits that have the value 0 and form a contiguous string of bits with the bit at the second end, thereby forming a revised subunit for any subunit that has a 0 at the second end.

4. The method according to claim 3, wherein a computer algorithm:
(a) reviews each subunit to determine whether at the second end there is a 0 and if so removes the 0 to form a revised subunit with a revised second end at a position that was adjacent to the second end of the subunit;
(b) reviews each revised subunit to determine whether at the revised second end there is a 0 and if so removing the 0 to form a further revised second end; and
(c) repeating (b) for each revised subunit until a shortened subunit is generated that has a 1 at its second end.

5. The method according to claim 2, wherein each subunit has a first end and a second end and prior to assigning said marker, the method further comprises analyzing one or more bits within each subunit of each chunklet to determine if the bit at the second end has a value 1 and if the bit at the second end has a value 1, removing the bit at the second end and all bits that have the value 1 and form a contiguous string of bits with the bit at the second end, thereby forming a revised subunit for any subunit that has a 1 at the second end.

6. The method according to claim 5, wherein a computer algorithm:
(a) reviews each subunit to determine whether at the second end there is a 1 and if so removes the 1 to form a revised subunit with a revised second end at a position that was adjacent to the second end of the subunit;
(b) reviews each revised subunit to determine whether at the revised second end there is a 1 and if so removing the 1 to form a further revised second end; and
(c) repeating (b) for each revised subunit until a shortened subunit is generated that has a 0 at its second end.

7. The method according to claim 2, wherein the markers are stored in a frequency converter, the markers are a plurality of different sizes and markers of a smaller size are correlated with higher frequency subunits.

8. The method according to claim 1, wherein a plurality of different markers are formed from different numbers of bits.

9. A method for retrieving data from a recording medium comprising:
i. accessing a recording medium, wherein the recording medium stores a plurality of markers in an order;
ii. translating the plurality of markers into a set of chunklets, wherein each chunklet is N bits long, wherein N is an integer number greater than 1 and wherein the chunklets have an order that corresponds to the order of the plurality of markers and wherein the translating is accomplished by accessing a bit marker table, wherein within the bit marker table each unique marker is identified as corresponding to a unique string of bits; and
iii. generating an output that comprises the set of chunklets.

10. The method according to claim 9, wherein the plurality of markers as stored on the recording medium have sizes from X to Y wherein Y>X and at least one marker has a size X and at least one marker has a size Y.

11. The method according to claim 10, wherein said translating comprises rendering all of the markers that are smaller than length Z into markers of a length Z by adding 0's to a first end of the markers, wherein Z is greater than or equal to Y and translating the markers of length Z into chunklets, wherein the chunklets are larger than length Z.

12. The method according to claim 11, wherein said translating the markers of length Z into chunklets comprises translating the markers of length Z into subunits and combining the subunits into markers.

13. A method for retrieving a document from storage comprising the method of claim 9, and further comprising associating the output with a file type and transmitting the output to an operating system that is capable of converting the chunklets into a document of said file type.

14. A method for storing data on a recording medium comprising:
i. receiving a plurality of digital binary signals, wherein the digital binary signals are organized in chunklets, wherein each chunklet is N bits long, each chunklet has a first end and a second end, N is an integer number greater than 1, and the chunklets have an order;
ii. dividing each chunklet into a plurality of subunits, wherein each subunit is A bits long;
iii. analyzing each subunit to determine if the bit at the second end has value 0 and if the bit at the second end has a value 0, removing the bit at the second end and all bits that have the value 0 and form a contiguous string of bits with the bit at the second end, thereby forming a revised chunklet for any chunklet that has a 0 at the second end; and
iv. on a non-transitory recording medium, storing in said order each revised subunit and each subunit that is A bits long and has a 1 at its second end.

15. A method for storing data on a recording medium comprising:
i. receiving a plurality of digital binary signals, wherein the digital binary signals are organized in chunklets, wherein each chunklet is N bits long, each chunklet has a first end and a second end, N is an integer number greater than 1, and the chunklets have an order;
ii. dividing each chunklet into a plurality of subunits, wherein each subunit is A bits long;
iii. analyzing each subunit to determine if the bit at the first end has a value 0 and if the bit at the first end has a value 0, removing the bit at the first end and all bits that have the value 0 and form a contiguous string of bits with the bit at the first end, thereby forming a first revised subunit for any subunit that has a 0 at the first end;
iv. analyzing each subunit to determine if the bit at the second end has value 0 and if the bit at the second end has a value 0, removing the bit at the second end and all bits that have the value 0 and form a contiguous string of bits with the bit at the second end, thereby forming a second revised subunit for any subunit that has a 0 at the second end; and
v. for each subunit
(a) if the sizes of the first revised subunit and the second revised subunit are the same, storing the first revised subunit or the second revised subunit,
(b) if the first revised subunit is smaller than the second revised subunit, storing the first revised subunit,
(c) if the second revised subunit is smaller than the first revised subunit, storing the second revised subunit,
(d) if there are no revised subunits, storing the subunit,
(e) if there is no first revised subunit, but there is a second revised subunit, storing the second revised subunit, and
(f) if there is no second revised subunit, but there is a first revised subunit, storing the first revised subunit,
wherein each revised subunit that is stored is stored with information that indicates if one or more bits were removed from the first end or the second end.

16. A method for retrieving data from a recording medium comprising:
i. accessing a recording medium, wherein the recording medium stores a plurality of data units in a plurality of locations, wherein each data unit contains a plurality of bits and the maximum size of the data unit is N bits, at least one data unit contains fewer than N bits and the data units have an order;
ii. retrieving the data units and adding one or more bits at an end of any data unit that is less than N bits long to generate a set of chunklets that correspond to the data units, wherein each chunklet contains the same number of bits; and
iii. generating an output that comprises the set of chunklets in an order that corresponds to the order of the data units.

17. The method according to claim 16, wherein in (ii) bits of value 0 are added.

18. A method for retrieving a document from storage comprising the method of claim 17, and further comprising associating the output with a file type and transmitting the output to an operating system that is capable of converting the chunklets into a document of said file type.
